(19) United States
(12) Patent Application Publication
(10) Pub. No.: US 2019/0005155 A1
(43) Pub. Date: Jan. 3, 2019

(54) Visualization management device, data management device, data visualization system, visualization management method, and program product

(71) Applicant: Kabushiki Kaisha Toshiba, Minato-ku (JP)

(72) Inventors: Xinxiao Li, Yokohama (JP); Hidenori Matsuzaki, Fuchu (JP); Dan Umeda, Nerima (JP)

(73) Assignee: Kabushiki Kaisha Toshiba, Minato-ku (JP)

(21) Appl. No.: 15/932,196

(22) Filed: Feb. 16, 2018

(30) Foreign Application Priority Data
Jun. 30, 2017 (JP) 2017-129399

(51) Int. Cl. G06F 17/30; G06F 21/60

(52) U.S. Cl. CPC G06F 17/30994; G06F 21/602; G06F 17/30967

(57) ABSTRACT

A sever communicates with a terminal device and a data management device. The terminal device displays a visualization screen. The data management device generates aggregate data in which original data is aggregated. The server includes one or more circuitry configured to receive customization information indicating setting related to the visualization screen from the terminal device, cause a storage to store therein screen configuration information indicating a screen configuration of the visualization screen based on the customization information, create a request for generating the aggregate data based on the customization information and the screen configuration information, and transmit the request to the data management device.

### CROSS-REFERENCE TO RELATED APPLICATIONS

This application is based upon and claims the benefit of priority from Japanese Patent Application No. 2017-129399, filed on Jun. 30, 2017; the entire contents of which are incorporated herein by reference.

### FIELD

Embodiments described herein relate generally to a visualization management device, a data management device, a data visualization system, a visualization management method, and a program product.

### BACKGROUND

In various fields such as research and development, performance analysis, production management, and marketing, a system for visualizing collected data (big data) is used. For example, there is a device that creates graphs based on numerical data given as time-series data and displays these graphs, wherein a first graph indicating a result of aggregation of numerical data within an arbitrary aggregation period in a chronological order, a second graph indicating an aggregated result related to a first attribute in the aggregation period indicated in the first graph, and a third graph indicating an aggregated result related to a second attribute in the aggregation period indicated in the first graph are displayed, and the second graph and the third graph are updated according to an operation of changing the aggregation period in the first graph.

When data sources as visualization targets and terminal devices (renderers) that cause visualization screens to be displayed exist in a distributed manner, a server (such as a visualization management device and a cloud service) that centrally manages information related to these data sources and renderers is required. Further, when such data sources are large scale devices, data to be transmitted to renderers needs to be aggregated according to need. If all of such aggregating processes are performed by a server, the load on the server may be excessive. Further, when aggregating processes are performed, the contents of data are read by the server, and thus the risk of information leakage is increased. In order to solve these problems, it is effective to distribute aggregating processes; however, in some conventional techniques, it is difficult to achieve the distribution of processes and central management of information at the same time.

### BRIEF DESCRIPTION OF THE DRAWINGS

FIG. 1 is a diagram exemplifying a system configuration of a data visualization system according to a first embodiment;

FIG. 2 is a diagram exemplifying a hardware configuration of a data management device, a terminal device, and a server according to the first embodiment;

FIG. 3 is a block diagram exemplifying a functional configuration of a data processor according to the first embodiment;

FIG. 4 is a block diagram exemplifying a functional configuration of a data renderer according to the first embodiment;

FIG. 5 is a block diagram exemplifying a functional configuration of a mediating processor according to the first embodiment;

FIG. 6 is a diagram exemplifying a visualization screen created by a data visualization system according to a first example of the first embodiment;

FIG. 7 is a diagram exemplifying a visualization screen created by a data visualization system according to a second example of the first embodiment;

FIG. 8 is a conceptual diagram exemplifying a state of central management in the data visualization system according to the first embodiment;

FIG. 9 is a diagram exemplifying a data structure of screen configuration information according to the first embodiment;

FIG. 10 is a diagram exemplifying a rendering mode of a program in the data visualization system according to the first embodiment;

FIG. 11 is a sequence diagram exemplifying a flow of a process from a user performing a screen operation to the data renderer acquiring header data or visualization data in the data visualization system according to the first embodiment;

FIG. 12 is a diagram exemplifying a data structure of a request according to the first embodiment;

FIG. 13 is a conceptual diagram exemplifying an encrypting operation in the data visualization system according to the first embodiment;

FIG. 14 is a flowchart exemplifying a flow of a process of updating a visualization screen according to change of setting in the data visualization system according to the first embodiment;

FIG. 15 is a diagram exemplifying a data source list according to the first embodiment;

FIG. 16 is a diagram exemplifying a setting screen when a chart type is selected in the first embodiment;

FIG. 17 is a sequence diagram exemplifying a flow of a process from setting a data source and a chart type to setting data mapping in the data visualization system according to the first embodiment;

FIG. 18 is a sequence diagram exemplifying a flow of a process from setting data mapping to displaying a visualization screen in the data visualization system according to the first embodiment;

FIG. 19 is a diagram exemplifying data structures of original data, header data, and visualization data and display modes of a data-mapping setting screen and a visualization screen in the first embodiment;

FIG. 20 is a diagram exemplifying a system configuration of a data visualization system according to a second embodiment;

FIG. 21 is a block diagram exemplifying a functional configuration of a mediating processor according to the second embodiment;

FIG. 22 is a sequence diagram exemplifying a flow of a process from a user performing a setting operation to a data renderer displaying a visualization screen in the data visualization system according to the second embodiment;

FIG. 23 is a diagram exemplifying a system configuration of a data visualization system according to a third embodiment;

FIG. 24 is a block diagram exemplifying a functional configuration of a mediating processor according to the third embodiment;

FIG. 25 is a sequence diagram exemplifying a flow of a process from a user performing a setting operation to a first data renderer displaying a visualization screen in the data visualization system according to the third embodiment; and

FIG. 26 is a flowchart exemplifying a flow of a process of determining data renderers that are capable of sharing visualization data, among a plurality of data renderers in the third embodiment.

### DETAILED DESCRIPTION

### First Embodiment

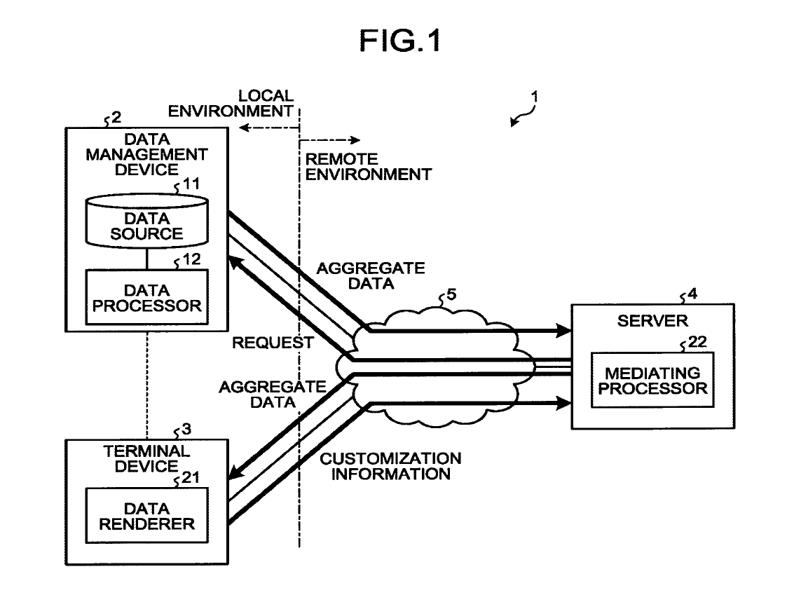

FIG. 1 is a diagram exemplifying a system configuration of a data visualization system 1 according to a first embodiment. The data visualization system 1 includes a data management device 2, a terminal device 3, a server 4 (visualization management device), and a network 5. The data visualization system 1 is a system that renders visualization data included in aggregate data, which is generated by the data management device 2, and causes the terminal device 3 to display a visualization screen.

The data management device 2 is an information processing device that manages data (original data) handled as a visualization target, and can be a general-purpose PC (Personal Computer) or a storage server, for example. The data management device 2 includes a data source 11 and a data processor 12. The data source 11 is a database that stores therein original data by using an appropriate storage device. The original data can be, for example, raw data (big data) collected by a predetermined method (such as an experiment and sensor detection). The data processor 12 is configured by using an appropriate integrated circuit, performs a predetermined process (such as an aggregating process) on the original data in the data source 11, and generates aggregate data. The aggregate data includes visualization data (small data) as a rendering target, header data indicating characteristics of attribute values included in the original data for each attribute (column), and the like. The data processor 12 according to the present embodiment generates, according to a request transmitted from the server 4, aggregate data from the original data.

The terminal device 3 is an information processing device that displays a visualization screen, and can be a PC, a tablet terminal, or a smartphone, for example. The terminal device 3 includes a data renderer 21. The data renderer 21 displays a visualization screen on an output device (a display, for example) by rendering visualization data generated by the data processor 12 of the data management device 2. Further, the data renderer 21 performs setting related to the visualization screen according to an operation by a user to create customization information indicating setting contents.

The server 4 is an information processing device that mediates communication between the data management device 2 and the terminal device 3, and can be a server computer or cloud services, for example. The server 4 includes a mediating processor 22. The mediating processor 22 centrally manages information related to the data management device 2 (the data source 11 and the data processor 12) and information related to the terminal device 3 (the data renderer 21). Further, the mediating processor 22 creates a request according to customization information and screen configuration information (indicating a screen configuration of a visualization screen) received from the terminal device 3, and transmits the created request to the data management device 2 (the data processor 12). Further, the mediating processor 22 receives aggregate data (visualization data or header data) from the data management device 2, and transfers the received aggregate data to the terminal device 3.

The network 5 is a computer network that enables communication among a plurality of information processing devices. In the present embodiment, it is assumed that the data management device 2 and the terminal device 3 are arranged in a local environment that is relatively close to a user, and the server 4 is arranged in a remote environment using a remote server or cloud services and the like. In this case, communication between the data management device 2 and the server 4 and communication between the terminal device 3 and the server 4 are respectively established in an individual manner via a communication network such as the Internet/Intranet. The data management device 2 and the terminal device 3 can be directly connected to each other via a LAN (Local Area Network).

The system configuration of the data visualization system 1 is not limited to the example described above. While FIG. 1 illustrates a configuration in which one data management device 2 and one terminal device 3 are connected to one server 4, and one data source 11 and one data processor 12 are present in one data management device 2, it is also possible to configure that, for example, a plurality of data management devices 2 and a plurality of terminal devices 3 are connected to one server 4. Further, a plurality of data sources 11 and a plurality of data processors 12 can be present in one data management device 2. It is not always necessary to arrange the data management device 2 and the terminal device 3 in a local environment, and for example, these devices can be arranged in a remote environment where data transfer between the data management device 2 and the terminal device 3 is efficient. Further, it is not always necessary to arrange the server 4 in a remote environment, and for example, the server 4 can be arranged in a local environment nearby the data management device 2 and the terminal device 3.

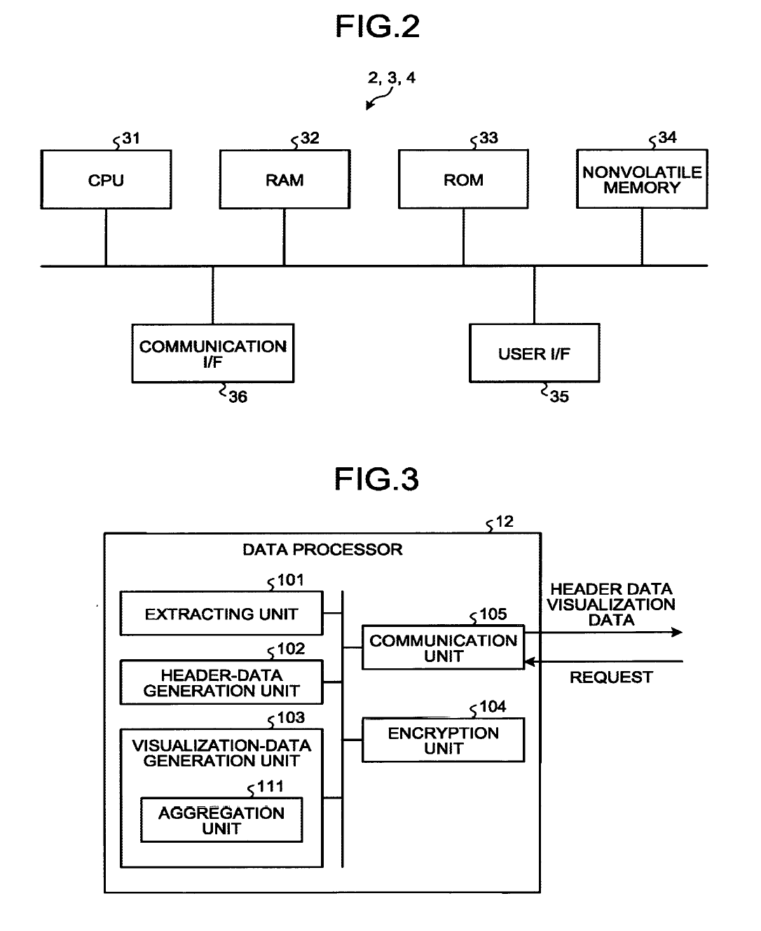

FIG. 2 is a diagram exemplifying a hardware configuration of the data management device 2, the terminal device 3, and the server 4 according to the first embodiment. The data management device 2, the terminal device 3, and the server 4 respectively includes a CPU (Central Processing Unit) 31, a RAM (Random Access Memory) 32, a ROM (Read Only Memory) 33, a nonvolatile memory 34, a user I/F (Interface) 35, and a communication I/F 36. The CPU 31 performs predetermined arithmetic processing according to a program stored in the ROM 33 or the nonvolatile memory 34, while using the RAM 32 as a working area. The user I/F 35 is a device (for example, a keyboard, a mouse, or a touch panel) that receives an operation by a user and by which information is input from outside, and is a device (for example, a display, a speaker, or a printer) that outputs information created in the user I/F 35 itself to outside. The communication I/F 36 is a device that enables transmission and reception of information between external devices via the network 5. The user I/F 35 is not necessarily provided in the data management device 2 and the server 4.

FIG. 3 is a block diagram exemplifying a functional configuration of the data processor 12 according to the first embodiment. The data processor 12 includes an extracting unit 101, a header-data generation unit 102 (aggregate data generation unit), a visualization-data generation unit 103 (aggregate data generation unit), an encryption unit 104, and a communication unit 105.

The respective units 101 to 105 are realized by one or plural integrated circuits. The respective units 101 to 105 can be also realized by causing a processor such as the CPU 31 to execute a program, that is, realized by software. Further, the respective units 101 to 105 can be also realized by a processor such as a dedicated IC (Integrated Circuit), that is, realized by hardware. Furthermore, the respective units 101 to 105 can be realized by using software and hardware at the same time. When a plurality of processors are used, each of the processors can realize any one of the respective units 101 to 105 or can realize two or more of the respective units 101 to 105.

The extracting unit 101 extracts original data from the data source 11 according to a request transmitted from the server 4.

The header-data generation unit 102 generates header data from original data extracted by the extracting unit 101 according to a request (a header data request) transmitted from the server 4. The header data is information indicating characteristics (an attribute value type and an attribute value range) of an attribute value of each column (each attribute) included in the original data. For example, when the column (attribute) is “temperature”, its attribute value is, for example, [10° C., 100° C.], and when the column is “room”, its attribute value is, for example, [room A, room B, room C]. The attribute value type indicates characteristics (type) of such an attribute value, and for example, when the column is “temperature”, the type of its attribute value can be regarded as “numerical”, and when the column is “room”, the type of the attribute value can be regarded as “nominal”. Such header data is used when a user operates the terminal device 3 to set data mapping of a chart. For example, it is possible to perform processes such as automatically excluding a column having an attribute value type of “nominal” from candidates of data mapping.

The visualization-data generation unit 103 generates visualization data from original data extracted by the extracting unit 101 according to a request (a visualization data request) transmitted from the server 4. The visualization-data generation unit 103 includes an aggregation unit ill. The aggregation unit 111 aggregates original data (big data) according to a received request, and generates visualization data (small data). The visualization data is data handled as a target of a rendering process of creating a visualization screen based on the original data.

The encryption unit 104 encrypts header data generated by the header-data generation unit 102 and visualization data generated by the visualization-data generation unit 103.

The communication unit 105 establishes communication with the server 4 via the network 5. The communication unit 105 receives a request transmitted from the server 4, and transmits encrypted header data or encrypted visualization data as a response to the request to the server 4. Further, the communication unit 105 can perform a predetermined authenticating process when communication with the server 4 is established.

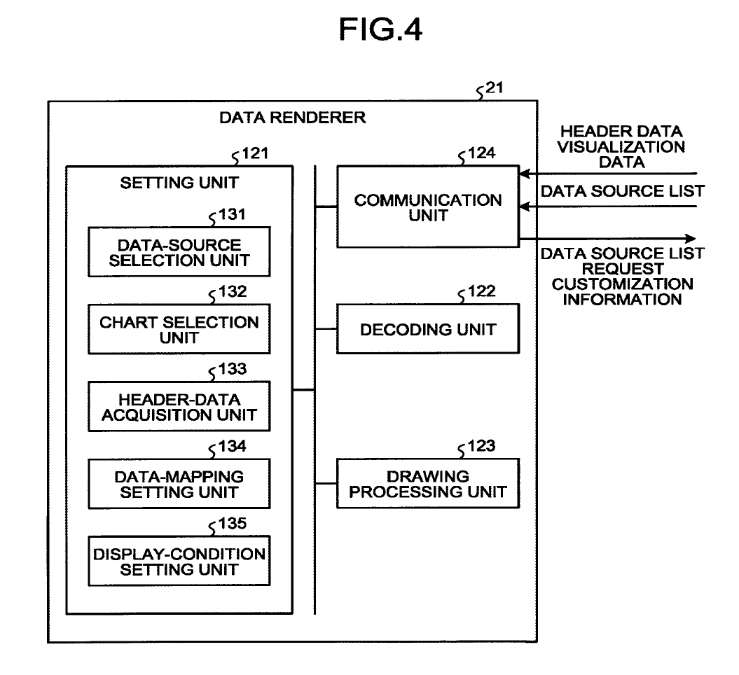

FIG. 4 is a block diagram exemplifying a functional configuration of the data renderer 21 according to the first embodiment. The data renderer 21 includes a setting unit 121, a decoding unit 122, a drawing processing unit 123, and a communication unit 124.

The respective units 121 to 124 are realized by one or plural integrated circuits. The respective units 121 to 124 can be also realized by causing a processor such as the CPU 31 to execute a program, that is, realized by software. Further, the respective units 121 to 124 can be also realized by a processor such as a dedicated IC (Integrated Circuit), that is, realized by hardware. Furthermore, the respective units 121 to 124 can be realized by using software and hardware at the same time. When a plurality of processors are used, each of the processors can realize any one of the respective units 121 to 124 or can realize two or more of the respective units 121 to 124.

The setting unit 121 receives operations of a user, performs various setting processes related to a visualization screen, and creates customization information indicating setting contents. The setting unit 121 includes a data-source selection unit 131, a chart selection unit 132, a header-data acquisition unit 133, a data-mapping setting unit 134, and a display-condition setting unit 135. The data-source selection unit 131 causes a user to select a data source 11 to be handled as a visualization target. At this time, a data source list having been transmitted from the server 4 is used. The data source list is information indicating data sources 11 that are selectable as visualization targets. The chart selection unit 132 causes a user to select a chart type (for example, a bar chart, a line chart, and the like). The header-data acquisition unit 133 acquires header data having been generated by the header-data generation unit 102 of the data processor 12. The data-mapping setting unit 134 causes a user to select a column corresponding to the chart selected by the chart selection unit 132. At this time (when a column corresponding to the chart is set), header data having been acquired by the header-data acquisition unit 133 is used. The display-condition setting unit 135 causes a user to set display conditions (for example, position and size of chart, numerical range of column, and the like) of a visualization screen. It is possible to configure that the display-condition setting unit 135 displays a setting screen for setting display conditions and causes a user to select display conditions, or that the display-condition setting unit 135 sets display conditions without displaying the setting screen and according to operations of a user with respect to the chart while the user is unaware of the setting performed by the display-condition setting unit 135. For example, it is possible to set display conditions automatically according to operations of a user such that the user uses an input device such as a mouse to select his interest or ranges. The setting unit 121 creates customization information including contents set by these functional units, that is, customization information including the data source 11, the chart type, setting of data mapping (setting of columns), display conditions, and the like.

The decoding unit 122 decodes header data and visualization data that are encrypted by the encryption unit 104 of the data processor 12.

By performing rendering on the decoded visualization data, the drawing processing unit 123 creates a visualization screen and displays the created visualization screen on an output device.

The communication unit 124 establishes communication with the server 4 via the network 5. The communication unit 124 transmits a data-source list request and customization information to the server 4, and receives a data source list, encrypted header data, and encrypted visualization data from the server 4. Further, the communication unit 124 can perform a predetermined authenticating process when communication with the server 4 is established.

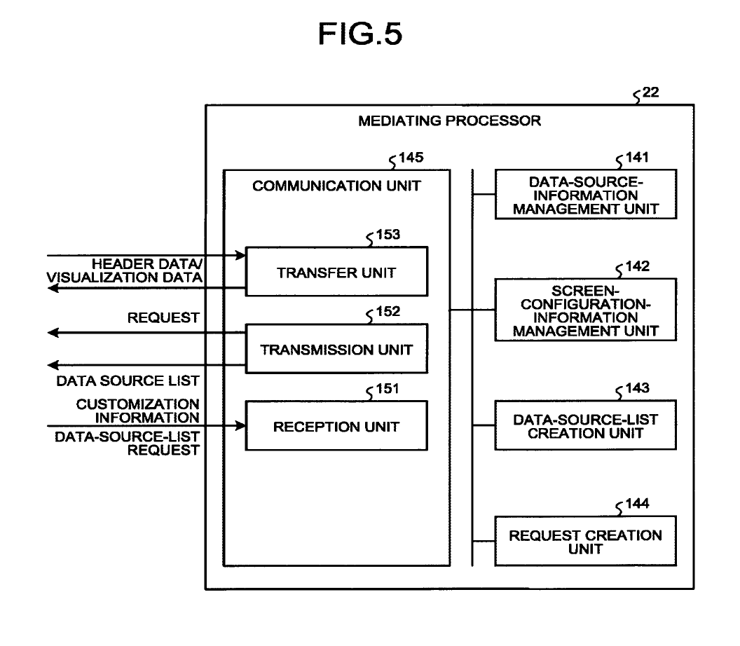

FIG. 5 is a block diagram exemplifying a functional configuration of the mediating processor 22 according to the first embodiment. The mediating processor 22 includes a data-source-information management unit 141, a screen-configuration-information management unit 142, a data-source-list creation unit 143, a request creation unit 144, and a communication unit 145.

The respective units 141 to 145 are realized by one or plural integrated circuits. The respective units 141 to 145 can be also realized by causing a processor such as the CPU 31 to execute a program, that is, realized by software. Further, the respective units 141 to 145 can be also realized by a processor such as a dedicated IC (Integrated Circuit), that is, realized by hardware. Furthermore, the respective units 141 to 145 can be realized by using software and hardware at the same time. When a plurality of processors are used, each of the processors can realize any one of the respective units 141 to 145 or can realize two or more of the respective units 141 to 145.

The data-source-information management unit 141 manages information related to data sources 11 that can be selected as visualization targets. The data-source-information management unit 141 determines, for example, data sources 11 in the data management device 2 being connected to the server 4 as “active” data sources 11 that can be selected as visualization targets. Accordingly, the data sources 11 can be managed centrally and dynamically to add new “active” data sources and to delete “inactive” data sources.

The screen-configuration-information management unit 142 manages screen configuration information related to a screen configuration of a visualization screen to be displayed on each terminal device 3 based on customization information transmitted from the terminal device 3. The screen-configuration-information management unit 142 stores screen configuration information of each visualization screen in an appropriate storage unit (for example, the nonvolatile memory 34), and updates the screen configuration information stored in the storage unit according to change of customization information. Accordingly, the state of the visualization screen being displayed on the terminal device 3 can be managed centrally and dynamically.

The data-source-list creation unit 143 creates, according to a data-source-list request transmitted from the data renderer 21 and based on information managed by the data-source-information management unit 141, a data source list indicating data sources 11 that is “active” (can be currently selected as visualization targets).

The request creation unit 144 creates a request to the data management device 2 (the data processor 12) based on customization information transmitted from the terminal device 3 and screen configuration information managed by the screen-configuration-information management unit 142. The created request includes a header data request and a visualization data request.

The communication unit 145 establishes communication between the data management device 2 and the terminal device 3 via the network 5. The communication unit 145 includes a reception unit 151, a transmission unit 152, and a transfer unit 153. The reception unit 151 receives a data-source-list request and customization information transmitted from the terminal device 3. The transmission unit 152 transmits a data source list to the terminal device 3 (the data renderer 21), and transmits requests (a header data request and a visualization data request) to the data management device 2 (the data processor 12). The transfer unit 153 relays encrypted header data and encrypted visualization data transmitted from the data management device 2 to the terminal device 3.

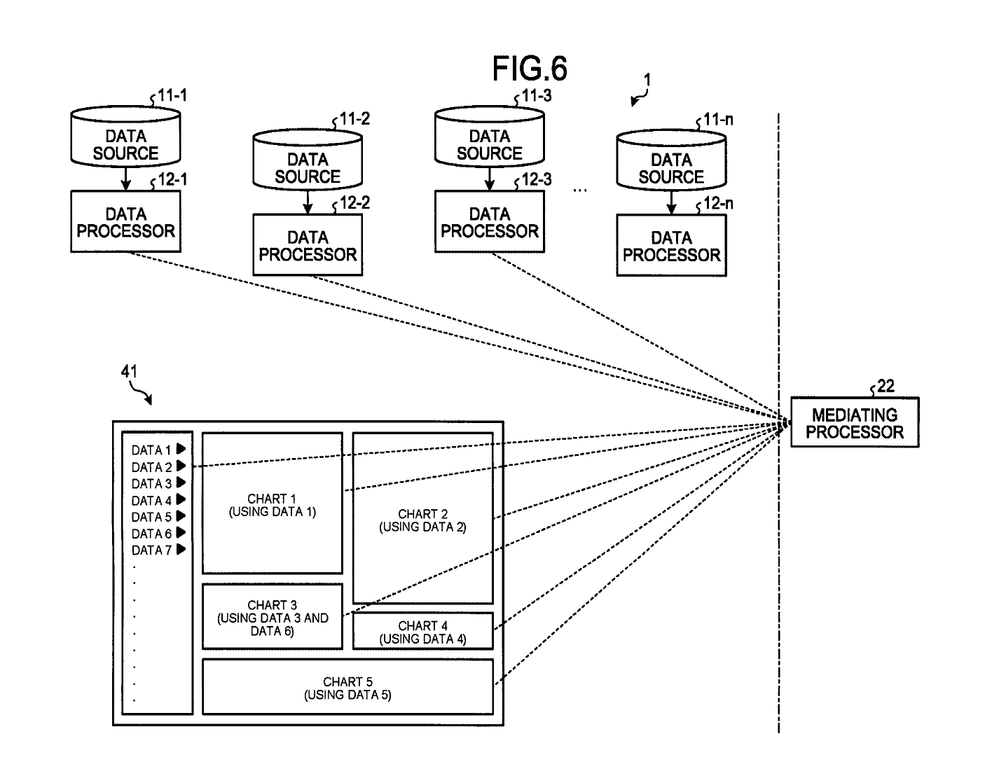

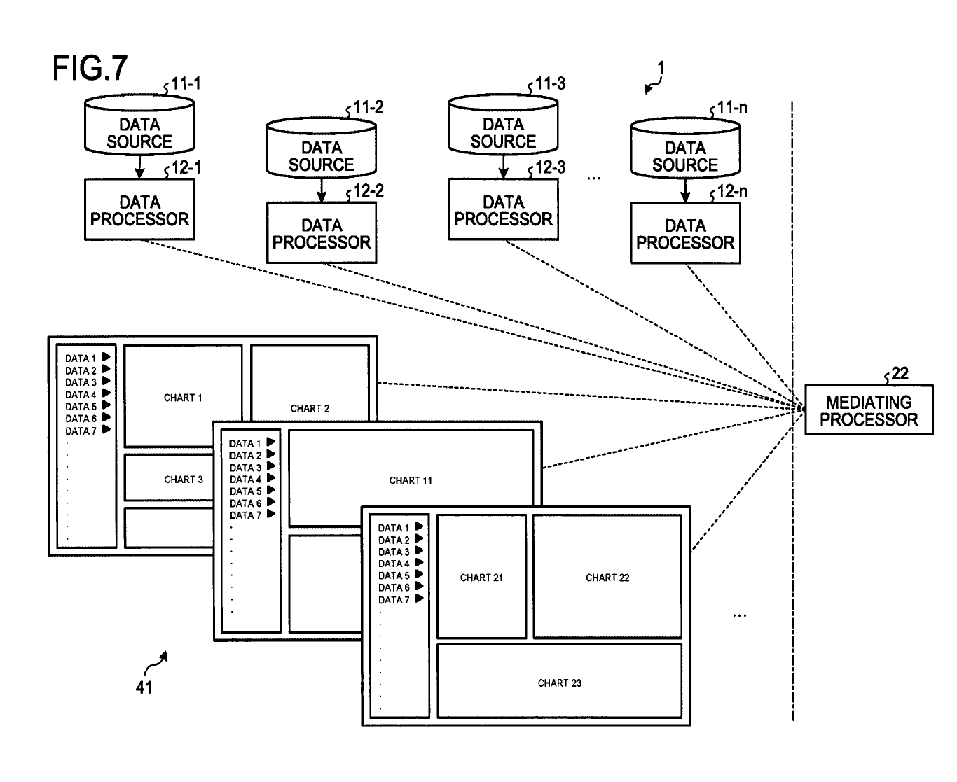

FIG. 6 is a diagram exemplifying a visualization screen 41 created by the data visualization system 1 according to a first example of the first embodiment. FIG. 7 is a diagram exemplifying a visualization screen 41 created by the data visualization system 1 according to a second example of the first embodiment.

FIG. 6 exemplifies a configuration of the visualization screen 41 that is created when a plurality of data sources 11-1 to 11-n, a plurality of data processors 12-1 to 12-n, and one terminal device 3 are included in the data visualization system 1 according to the first embodiment. In this example, a plurality of charts are drawn on one visualization screen 41, and data (visualization data generated by each of the data processors 12-1 to 12-n) of respectively different data sources 11-1 to 11-n is used in each of the charts. The mediating processor 22 according to this example centrally manages the plurality of data sources 11-1 to 11-n and screen configurations (each state of a plurality of charts) of the visualization screen 41.

FIG. 7 exemplifies a configuration of the visualization screen 41 that is created when a plurality of data sources 11-1 to 11-n, a plurality of data processors 12-1 to 12-n, and a plurality of terminal devices 3 are included in the data visualization system 1 according to the first embodiment. In this example, a plurality of charts are drawn on each of a plurality of visualization screens 41, and data (visualization data generated by each of the data processors 12-1 to 12-n) of respectively different data sources 11-1 to 11-n is used in each of the charts. The mediating processor 22 according to this example centrally manages the plurality of data sources 11-1 to 11-n and screen configurations of the plurality of visualization screens 41.

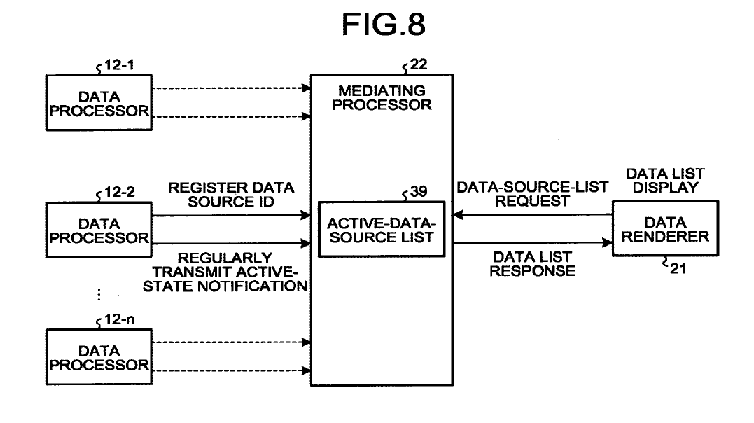

FIG. 8 is a conceptual diagram exemplifying a state of central management in the data visualization system 1 according to the first embodiment. The mediating processor 22 holds an active-data-source list 39 indicating data sources 11 that can be currently selected as visualization targets. Each of the plurality of data processors 12-1 to 12-n registers a data source ID that identifies the processor itself in the mediating processor 22, and regularly transmits an active-state notification indicating that the processor itself is in an active state. The mediating processor 22 updates the active-data-source list 39 in real-time based on the data source ID and the active-state notification. When the data renderer 21 transmits a data-source-list request to the mediating processor 22, the mediating processor 22 extracts a data source list from the latest active-data-source list 39, and transmits the extracted data source list to the data renderer 21 as a transmission source of the corresponding request. Accordingly, the mediating processor 22 can dynamically manage the data source list.

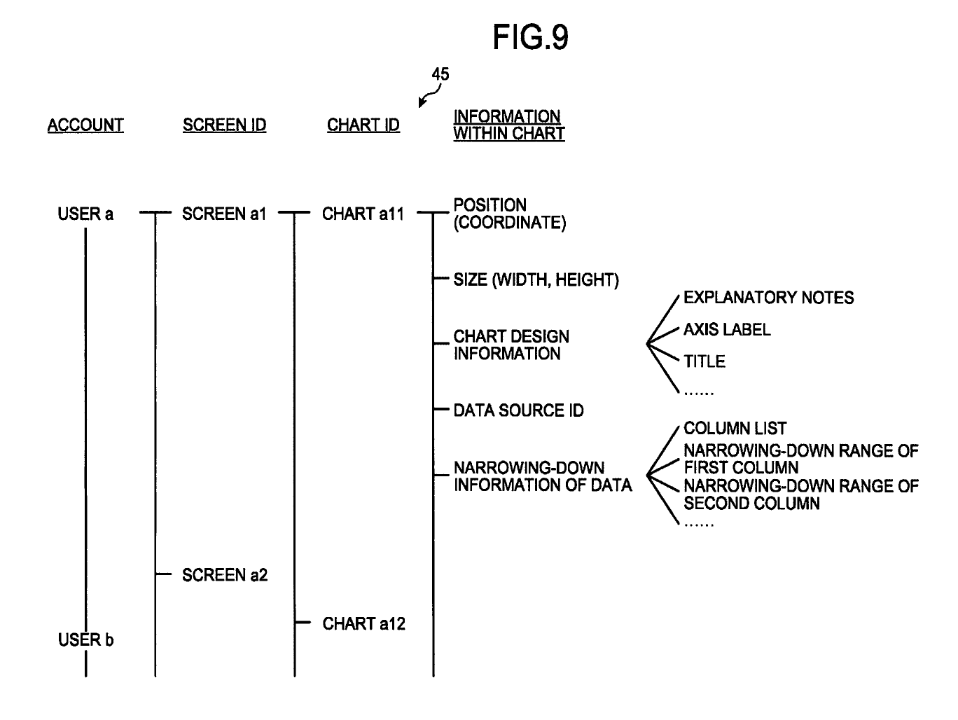

FIG. 9 is a diagram exemplifying a data structure of screen configuration information 45 according to the first embodiment. The screen configuration information 45 according to this example includes an account for identifying a user, a screen ID for identifying the visualization screen 41, a chart ID for identifying a chart to be drawn in the visualization screen 41, and chart-content information indicating configurations in the chart. The chart-content information includes a position (coordinate) of a chart in the visualization screen 41, a size of the chart (width and height), chart design information (for example, explanatory note, axis label, and title), a data source ID for identifying the data source 11 used for creating the chart, and narrowing-down information of data in the chart (for example, column list, first column narrowing-down range (numerical/nominal/ordinal range), and second column narrowing-down range, etc.). The chart ID is identification information enabling a plurality of charts included in the same visualization screen 41 to be identified. The chart ID is specifies chart-content information. The screen configuration information 45 can be an aggregate of a screen ID, a plurality of chart IDs specified by the screen ID, chart-content information referred by each of the chart IDs, and the like. By managing the screen configuration information 45 with respect to each terminal device 3 (each data renderer 21) or each visualization screen 41 individually, information of a plurality of visualization screens 41 can be centrally managed.

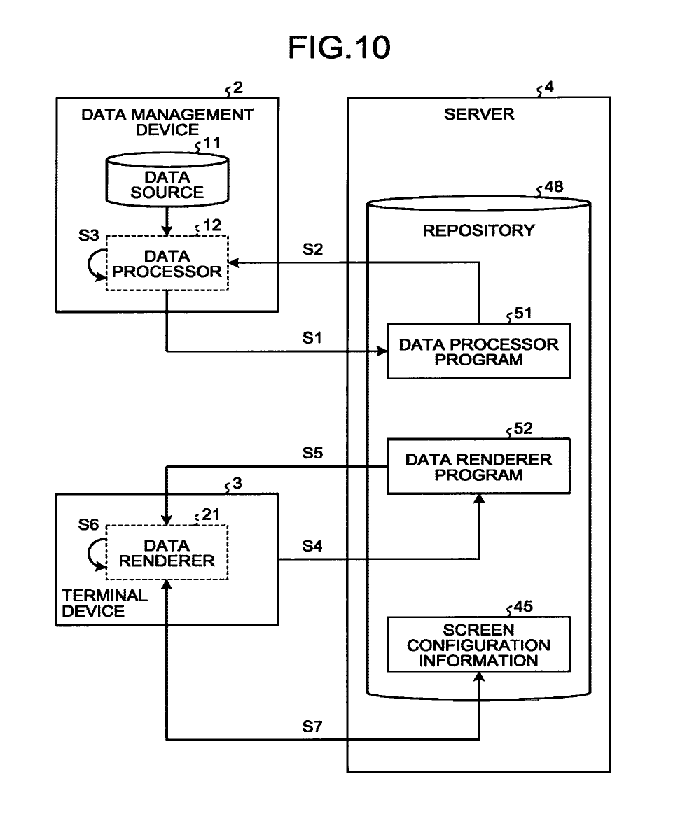

FIG. 10 is a diagram exemplifying a rendering mode of a program in the data visualization system 1 according to the first embodiment. The server 4 according to this example includes a repository 48 that stores therein a data processor program 51, a data renderer program 52, and the screen configuration information 45. The repository 48 can be configured by using the nonvolatile memory 34 and the like.

When the data management device 2 accesses the server 4 (the mediating processor 22) (S1), the server 4 deploys the data processor program 51 to the data management device 2 as an access source (S2), and the data management device 2 installs the received data processor program 51 therein to realize the functions of the data processor 12 in the device itself (S3). When the terminal device 3 accesses the server 4 (S4), the server 4 transmits the data renderer program 52 to the terminal device 3 as the access source (S5), and the terminal device 3 installs the received data renderer program 52 therein to realize the functions of the data renderer 21 in the device itself (S6). The server 4 creates and updates the screen configuration information 45 of each visualization screen 41 based on customization information transmitted from the data renderer 21 (S7).

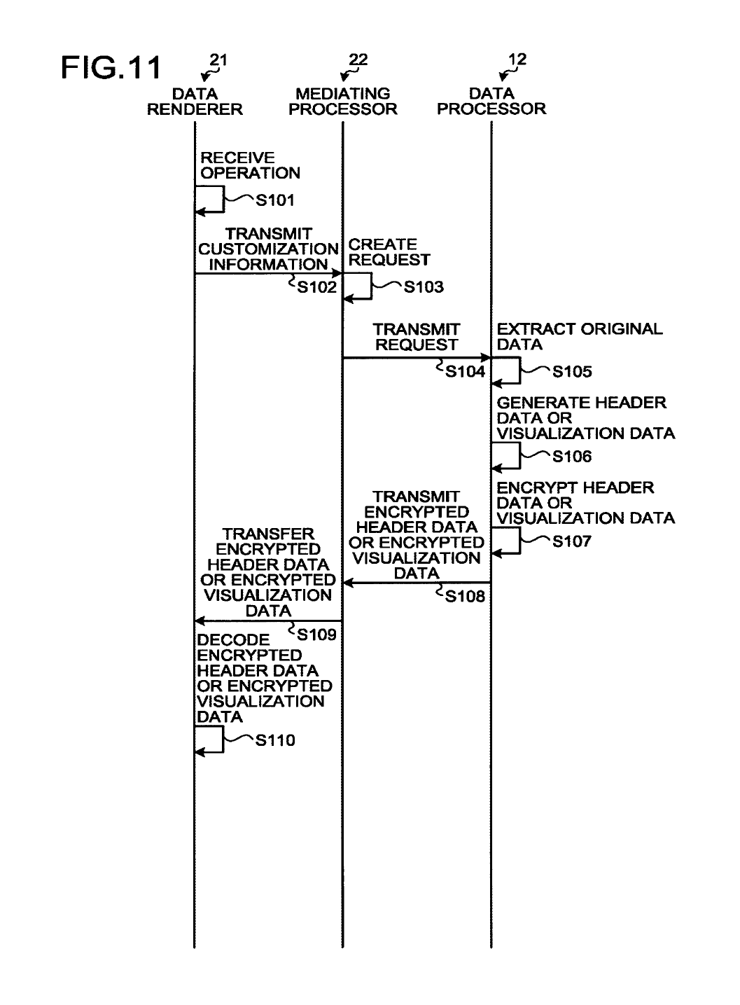

FIG. 11 is a sequence diagram exemplifying a flow of a process from a user performing a screen operation to the data renderer 21 acquiring header data or visualization data in the data visualization system 1 according to the first embodiment. Upon reception of an operation by a user (S101), the data renderer 21 creates customization information having operation contents reflected thereon and transmits the created customization information to the mediating processor 22 (S102). Upon reception of the customization information, the mediating processor 22 creates a request (a header data request or a visualization data request) corresponding to the setting contents (S103), and transmits the request to the data processor 12 (S104).

Upon reception of the request, the data processor 12 extracts original data corresponding to the request from the data source 11 (S105), and generates header data or visualization data (S106). Subsequently, the data processor 12 encrypts the generated header data or generated visualization data (S107), and transmits the encrypted header data or encrypted visualization data to the mediating processor 22 as a response to the request (S108). The mediating processor 22 relays the received encrypted header data or encrypted visualization data to the data renderer 21 as a transmission source of the customization information (S109). The data renderer 21 decodes the received encrypted header data or encrypted visualization data (S110).

According to the processes described above, header data and visualization data are generated by the data processor 12, and are acquired by the terminal device 3 in an encrypted state. At this time, the server 4 only relays the encrypted data from the data processor 12 to the data renderer 21, and thus it is possible to decrease the risk of information leakage and the like in the server 4.

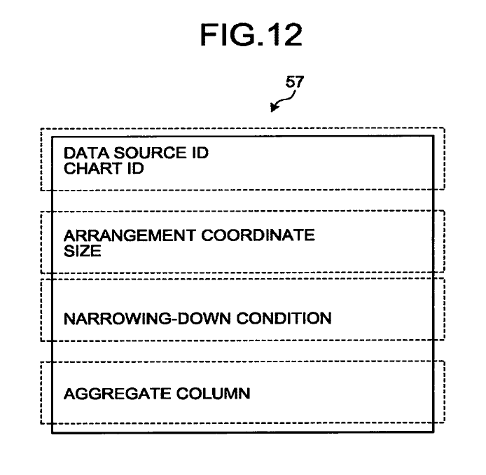

FIG. 12 is a diagram exemplifying a data structure of a request 57 according to the first embodiment. The request 57 according to this example is an example of a visualization data request for requesting visualization data to the data processor 12. The request 57 includes contents of customization information created according to an operation by a user, and in this example, the request 57 includes a data source ID indicating the data source 11, a chart ID indicating a chart type, an arrangement coordinate indicating a coordinate on a screen on which charts are arranged, a size indicating the size of chart, narrowing-down conditions indicating a range of data to be charted and the like, aggregate column specifying which columns will be aggregated for creating charts. According to the request 57 including these pieces of information, the data processor 12 aggregates original data (big data) in the data source 11 indicated by the data source ID, and generates visualization data (small data). For example, when the number of pieces of original data (the range of data to be charted) is larger than the resolution (the number of pixels) of a screen area in which a chart is displayed on a display, the data processor 12 generates visualization data by aggregating the original data such that the visualization data matches with the resolution (such that the data amount becomes requisite minimum for displaying a chart).

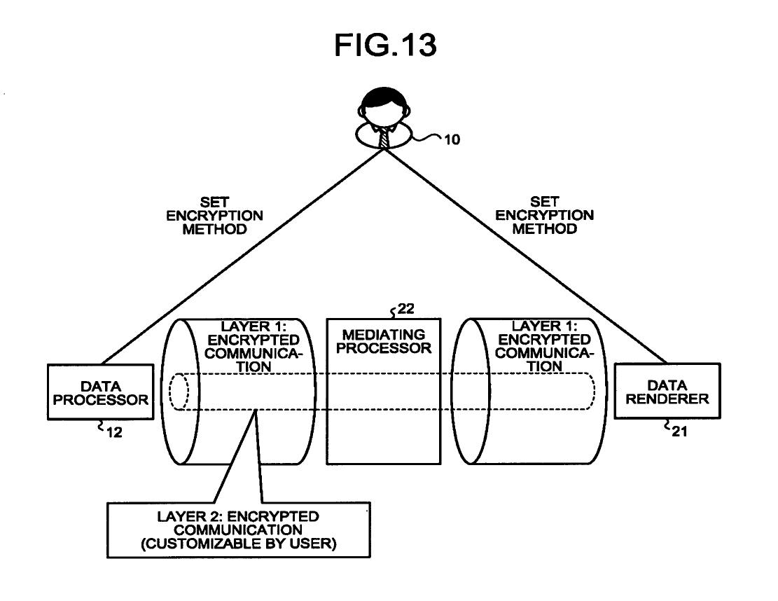

FIG. 13 is a conceptual diagram exemplifying an encrypting operation in the data visualization system 1 according to the first embodiment. As described above, in the present embodiment, the data processor 12 includes the encryption unit 104, the data renderer 21 includes the decoding unit 122, and the mediating processor 22 relays encrypted aggregate data (visualization data and header data) from the data processor 12 to the data renderer 21. An encryption method at this time can be arbitrarily set by a user 10. Due to this configuration, a layer 1 as an encrypted communication layer and a layer 2 as an encrypted communication layer that can be customized by the user 10 are constituted between the data processor 12 and the mediating processor 22. The layer 1 as an encrypted communication layer is constituted between the mediating processor 22 and the data renderer 21. Due to this configuration, it is possible to avoid the risk that aggregate data generated by the data processor 12 and original data in the data source 11 are leaked from communication path or the mediating processor 22, so that the security of the data visualization system 1 can be improved.

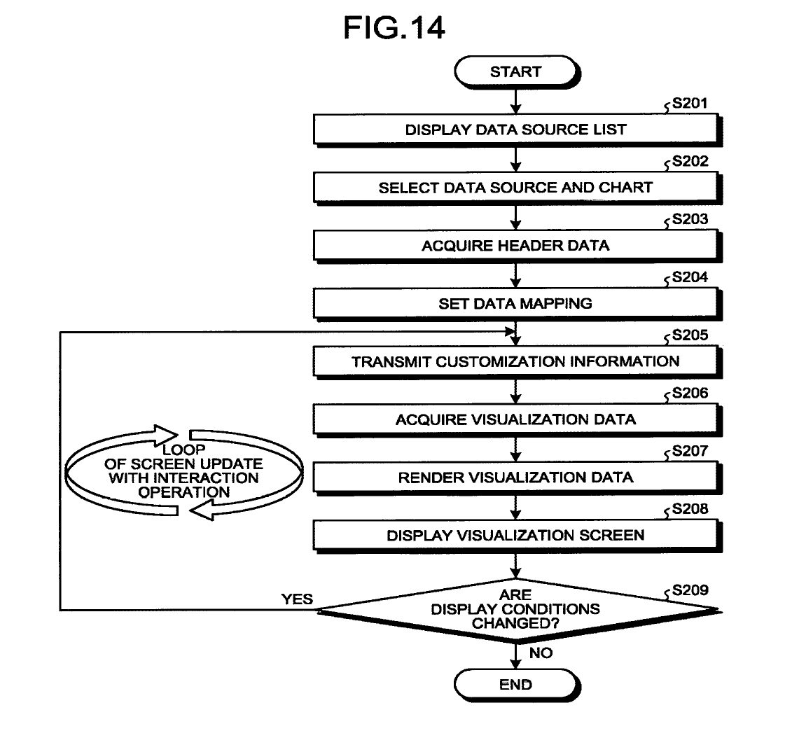

FIG. 14 is a flowchart exemplifying a flow of a process of updating the visualization screen 41 according to change of setting in the data visualization system 1 according to the first embodiment. When a user operates the terminal device 3 to start setting, the data-source selection unit 131 of the data renderer 21 displays a data source list on a display of the terminal device 3 (S201). The data source list shows one or more data sources 11 that can be handled as visualization targets, and is created based on information (the active-data-source list 39) created by the data-source-list creation unit 143 of the mediating processor 22.

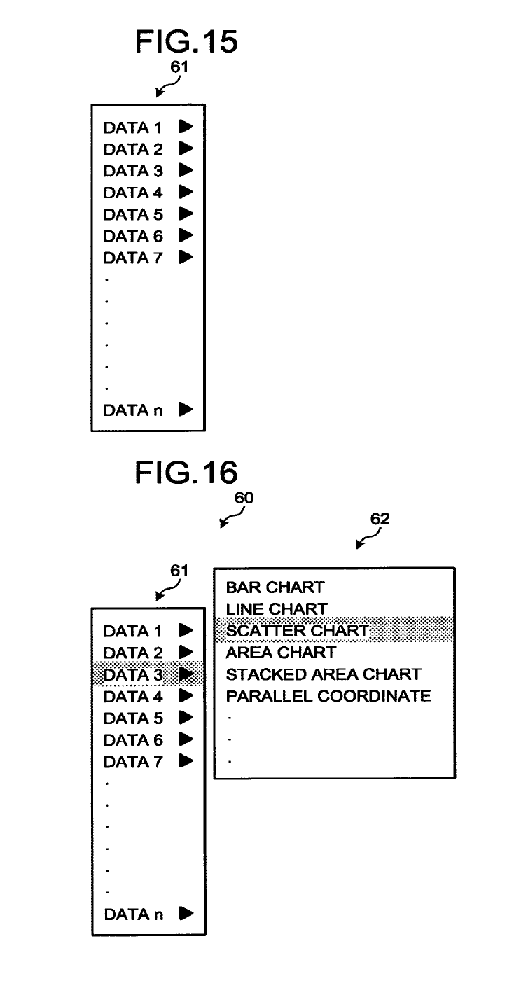

FIG. 15 is a diagram exemplifying the data source list 61 according to the first embodiment. n data sources 11 managed by one or more data management devices 2 being connected to the server 4 are listed on the data source list 61 according to this example. A user can select a desired data source 11 from the data source list 61 on a display.

Referring back to the flowchart of FIG. 14, when the data source list 61 is displayed as described above, a user selects a data source 11 from the data source list 61, and selects a desired chart type from a chart group associated with the selected data source 11 (S202).

FIG. 16 is a diagram exemplifying a setting screen 60 when a chart type is selected in the first embodiment. The setting screen 60 according to this example is configured that, when a user selects a desired data source 11 (in this example, data 3) from the data source list 61, a chart list 62 indicating a plurality of chart groups associated with the selected data source 11 is displayed, and the user can select a desired chart type (in this example, scatter chart) from the chart list 62. Such a setting screen 60 can be created based on information indicating a correspondence relation between the data source 11 and the chart type.

Referring back to the flowchart of FIG. 14, when the data source 11 and a chart type are selected as described above, the header-data acquisition unit 133 of the data renderer 21 acquires header data corresponding to the selected data source 11 (S203). The acquisition of the header data is performed with the process illustrated in the sequence diagram of FIG. 10. The header data indicates attribute values included in the data source 11 selected at Step S202 with respect to each attribute (column), and the header data includes, for example, information indicating the column being numerical, nominal, and the like. A numerical column is, for example, time, temperature, humidity, and the like. A nominal column is, for example, a name of experimental site (room), and the like. For example, in a line chart and the like, only numerical or ordinal columns are handled as data mapping targets and nominal columns are excluded from the data mapping targets. Subsequently, the user sets data mapping in the chart selected at Step S202 (S204).

Thereafter, the data renderer 21 creates customization information indicating the setting contents described above and transmits the created customization information to the server 4 (S205), and acquires visualization data generated by the data processor 12 via the server 4 (S206). The acquisition of the visualization data is performed with the process illustrated in the sequence diagram of FIG. 10. Subsequently, the data renderer 21 renders the acquired (decoded) visualization data (S207), and displays the visualization screen 41 on a display of the terminal device 3 (S208).

Thereafter, when the user changes display conditions on the displayed visualization screen 41 (YES at Step S209), the data renderer 21 transmits customization information indicating the changed setting contents (S205), and then a process of displaying a visualization screen 41 corresponding to the changed setting contents is performed (S206 to S208). The display conditions are, for example, chart type, position and size of chart, column type, and range of data in which columns are visualized. When the display conditions are not changed (NO at Step S209), this routine is ended. Due to the processes at Steps S205 to S209, a loop of screen update with an interaction operation is constituted.

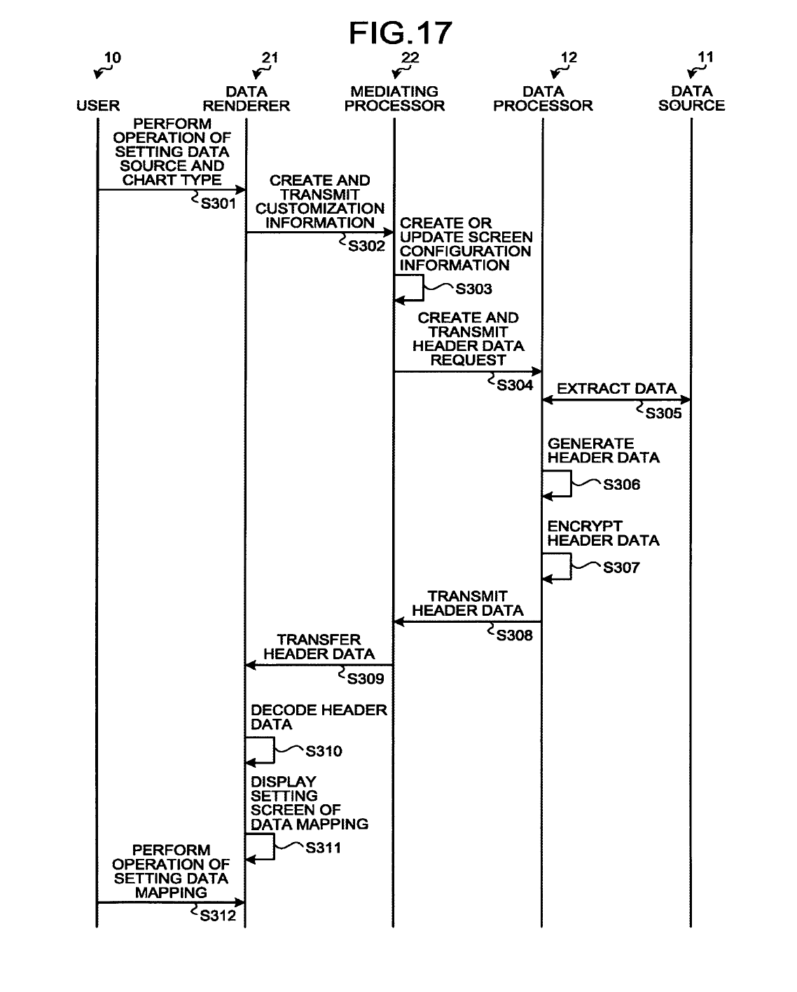

FIG. 17 is a sequence diagram exemplifying a flow of a process from setting the data source 11 and a chart type to setting data mapping in the data visualization system 1 according to the first embodiment. When the user 10 performs an operation of setting the data source 11 and a chart type with respect to the terminal device 3 (S301), the data renderer 21 creates customization information including the setting contents and transmits the customization information to the mediating processor 22 (S302). Upon reception of the customization information, the mediating processor 22 creates or updates the screen configuration information 45 corresponding to the user 10 or the data renderer 21 (S303), creates a header data request based on the customization information and the screen configuration information 45, and transmits the header data request to the data processor 12 (S304).

Upon reception of the header data request from the mediating processor 22, the data processor 12 extracts original data from the data source 11 (S305), and generates header data (S306). Subsequently, the data processor 12 encrypts the generated header data (S307), and transmits the encrypted header data to the mediating processor 22 (S308).

The mediating processor 22 relays the encrypted header data received from the data processor 12 to the data renderer 21 (S309). The data renderer 21 decodes the encrypted header data received from the mediating processor 22 (S310), and displays a setting screen for setting data mapping on a display of the terminal device 3 based on the decoded header data (S311). The user 10 performs an operation of setting data mapping via the setting screen (S312). The setting screen for setting data mapping at Step S311 is created based on the information included in the header data, that is, the type of attribute value (such as numerical or nominal/ordinal) of each column included in the original data of the data source 11 selected by the user and the range of the attribute value. By referring to the header data, it is possible that the data renderer 21 excludes columns that cannot be the target of data mapping (for example, nominal columns) from options and presents selectable columns (for example, numerical columns) and ranges thereof to the user on a setting screen and the like. Due to this configuration, the user 10 can appropriately perform setting of data mapping (selection of columns, adjustment of narrowing-down ranges, and the like) according to the chart type.

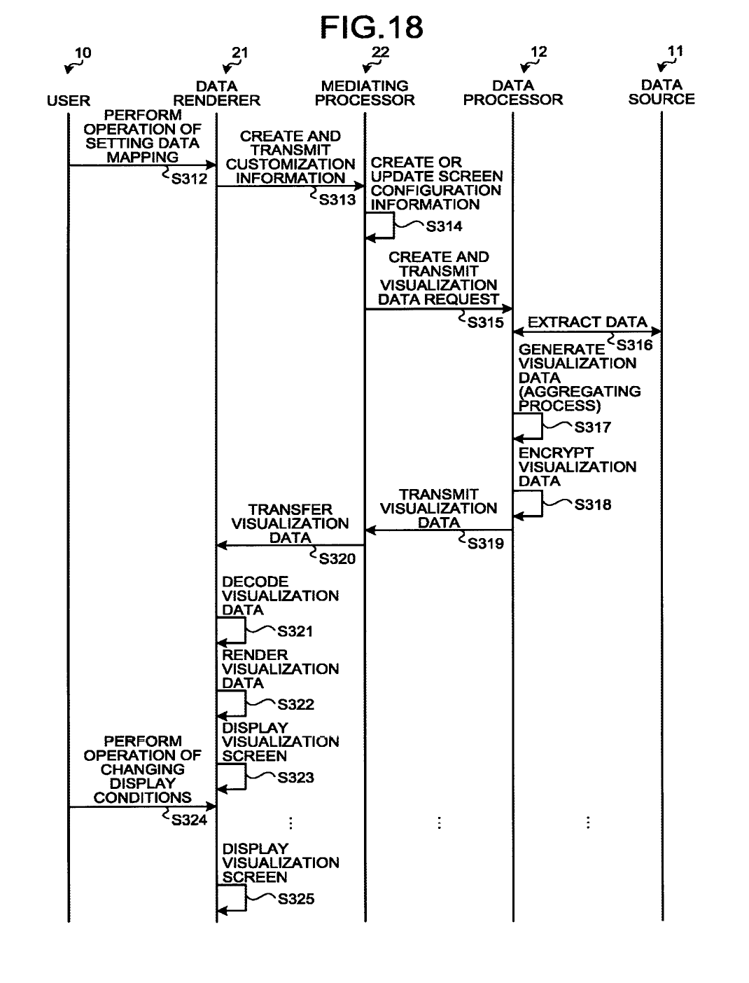

FIG. 18 is a sequence diagram exemplifying a flow of a process from setting data mapping to displaying the visualization screen 41 in the data visualization system 1 according to the first embodiment. When the user 10 performs an operation of setting data mapping on a setting screen (S312), the data renderer 21 creates customization information including the setting contents and transmits the customization information to the mediating processor 22 (S313). The mediating processor 22 creates or updates the screen configuration information 45 based on the received customization information (S314), and creates a visualization data request based on the customization information and the screen configuration information 45 and transmits the visualization data request to the data processor 12 (S315).

Upon reception of the visualization data request from the mediating processor 22, the data processor 12 extracts original data from the data source 11 based on the information included in the visualization data request (S316), and generates visualization data (S317). At this time, the aggregation unit 111 performs an aggregating process of aggregating original data based on the size of chart, narrowing-down conditions, resolutions of screen areas to be displayed, and the like. Subsequently, the data processor 12 encrypts the generated visualization data (S318), and transmits the encrypted visualization data to the mediating processor 22 (S319).

The mediating processor 22 transfers the encrypted visualization data received from the data processor 12 to the data renderer 21 (S320). The data renderer 21 decodes the encrypted visualization data received from the mediating processor 22 (S321), renders the decoded visualization data (S322), and displays the visualization screen 41 on a display of the terminal device 3 (S323).

Subsequently, when the user 10 performs an operation of changing the display conditions (such as narrowing-down conditions, data mapping, arrangement position of chart) on the visualization screen 41 (S324), the processes described above are performed again based on the changed display conditions, and an updated visualization screen 41 is displayed (S325).

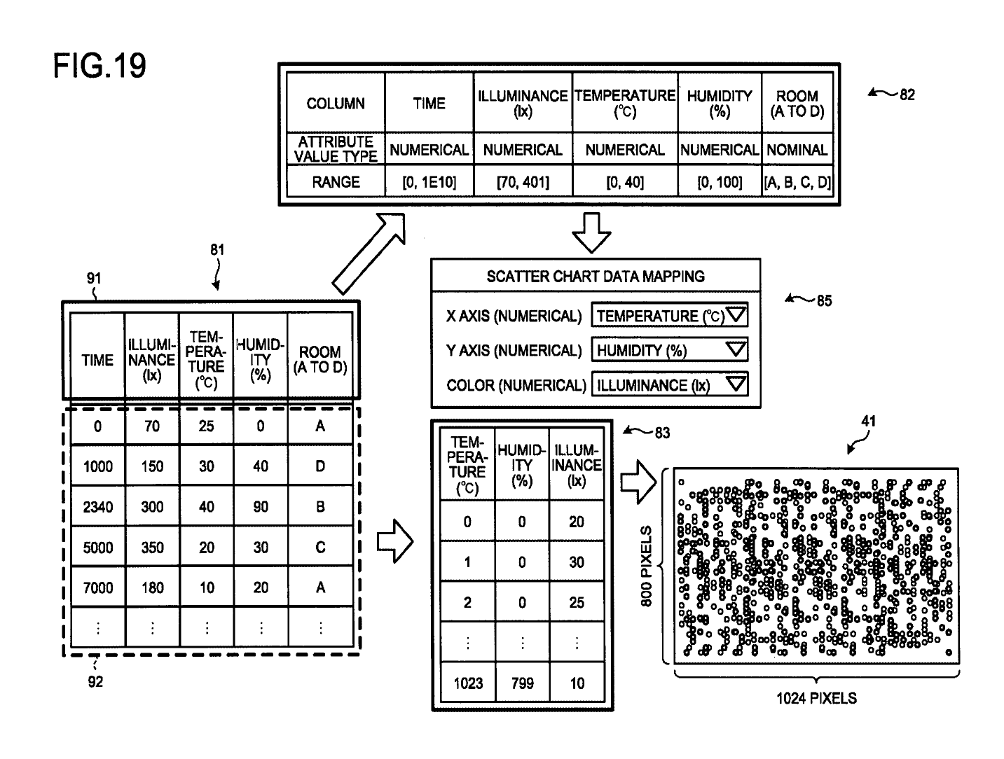

FIG. 19 is a diagram exemplifying data structures of original data 81, header data 82, and visualization data 83 and display modes of a data-mapping setting screen 85 and the visualization screen 41 in the first embodiment. The original data 81 according to this example includes five columns (attributes) 91 (“time”, “illuminance (lx)”, “temperature (° C.)”, “humidity (%)”, and “room (A to D)”) and attribute values 92 of the respective columns 91. In the header data 82, the column 91 of the original data 81, an attribute value type (such as numerical, ordinal or nominal) of each attribute value 92, and the range of each attribute value 92 are associated with one another.

The data-mapping setting screen 85 according to this example is an example of a case where “scatter chart” is selected by a user as the chart type. In order to create a scatter chart, it is necessary that three columns, which are an X-axis, a Y-axis, and a color, are selected and that the attribute value types of all of the columns are numerical. Therefore, “room” of which attribute value type is nominal, is not included in the options of the respective axes of the data-mapping setting screen 85 (in this example, options can be selected in a pull-down manner). In this manner, by creating the data-mapping setting screen 85 based on the header data 82, it is possible to prevent users from performing wrong setting of data mapping.

The visualization data 83 is information created by aggregating the original data 81 based on setting contents of data mapping, display conditions, and the like. The visualization data 83 is aggregated such that a chart is displayed appropriately based on, for example, the numerical ranges of columns set by a user, the size of chart, characteristics (resolution) of display, and the like. While a specific method of such an aggregating process is not particular limited to any method, for example, it is possible to use the mean value, the maximum value, the minimum value, and the like of a plurality of attribute values so that a plurality of pieces of data mapped on the same position (the same display coordinate) on a screen are aggregated as one piece of data. The visualization screen 41 can be created by rendering the visualization data 83 aggregated in this manner.

A program for realizing the functions of the data visualization system 1 described above can be distributed while being recorded in a computer-readable recording medium such as a CD-ROM, a flexible disk (FD), a CD-R, a DVD, and the like as a file of an installable formant or an executable format. Further, the program can be provided while being downloaded from a predetermined storage device being connected to a network to a predetermined computer, or can be provided in a predetermined information processing device while being incorporated in a ROM and the like in advance. The program can be constituted by a plurality of modules that realize at least a part of functions of the respective functional units illustrated in FIG. 3 to FIG. 5.

As described above, according to the present embodiment, because the data processor 12 that generates aggregate data (visualization data or header data) from original data (big data) corresponding to a request from the server 4 is provided to correspond to the data source 11, it is possible to distribute aggregating processes of the original data. Therefore, it is possible to realize central management of information processing devices (the data management device 2 and the terminal device 3 on a user side) by the server 4. Further, when aggregating processes are performed, it is possible to avoid the risk that the original data is read remotely by the server 4, and thus it is possible to decrease the risk of information leakage. In the present embodiment, there has been described an example in which an encrypting process is performed by the data processor 12 and a decoding process is performed by the data renderer 21; however, such encrypting process and decoding process are not always necessary to perform especially when the server 4 is in local environment along with data management device 2 and the terminal device 3. Even when the encrypting process and the decoding process are not performed, the basic configurations and the flow of data processing of the data visualization system 1 according to the present embodiment are not changed, and effects described above can be obtained.

While other embodiments are described below with reference to the drawings, parts identical to those of the first embodiment or parts having operational effects identical to those of the first embodiment are denoted by like reference characters and redundant explanations thereof may be omitted.

### Second Embodiment

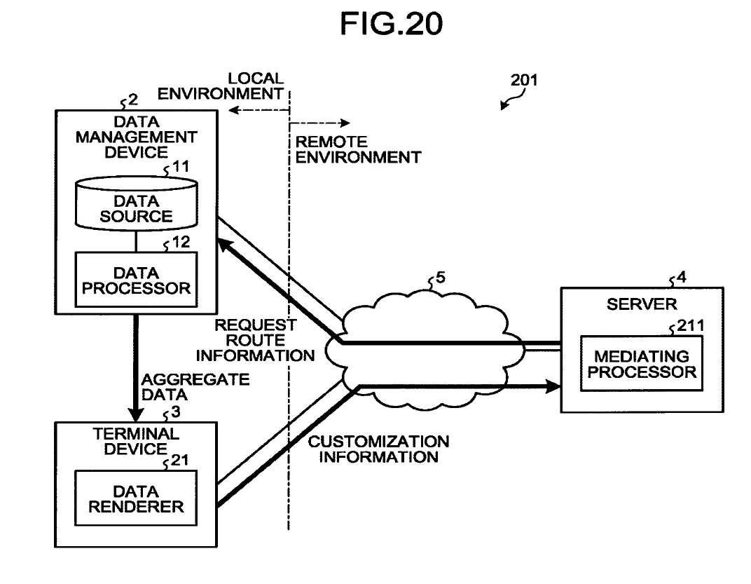

FIG. 20 is a diagram exemplifying a system configuration of a data visualization system 201 according to a second embodiment. In the data visualization system 1 according to the first embodiment described above, aggregate data generated by the data management device 2 (the data processor 12) is transmitted to the terminal device 3 via the server 4, whereas in the data visualization system 201 according to the present embodiment, aggregate data is directly transmitted from the data management device 2 (the data processor 12) to the terminal device 3 (the data renderer 21). A mediating processor 211 of the server 4 according to the present embodiment transmits route information to the data management device 2, and the data management device 2 establishes communication with the terminal device 3 based on the route information, and directly transmits the aggregate data to the terminal device 3.

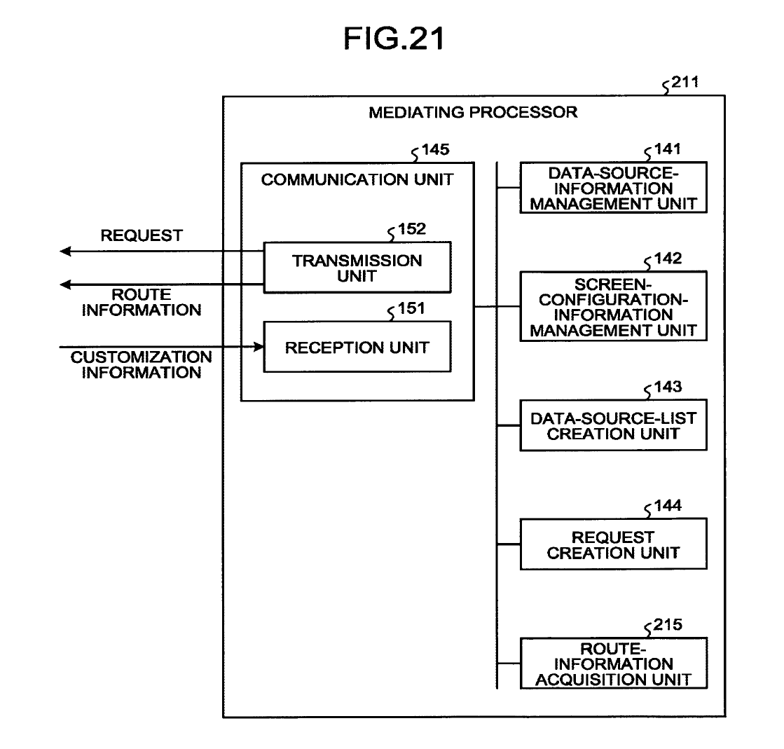

FIG. 21 is a block diagram exemplifying a functional configuration of the mediating processor 211 according to the second embodiment. The mediating processor 211 according to the present embodiment includes a route-information acquisition unit 215. Similarly to other functional units 141 to 145, the route-information acquisition unit 215 is realized by one or plural integrated circuits. Based on customization information received by the reception unit 151, the route-information acquisition unit 215 acquires route information for establishing communication between the data management device 2 as a transmission destination of a request and the terminal device 3 as a transmission source of the customization information. The route information may include an IP address, a port number, and the like of the data management device 2 as the transmission destination or the terminal device 3 as the transmission source. The route information is routinely collected and updated when communication is performed among the data management device 2, the terminal device 3, and the server 4. The transmission unit 152 according to the present embodiment transmits route information of a transmission source (for example, the terminal device 3) to a transmission destination of a request (for example, the data management device 2). Triggered by one side to connect the other side, the data management device 2 and the terminal device 3 establish a direct communication route based on the route information, and header data and visualization data are directly transmitted from the data management device 2 to the terminal device 3.

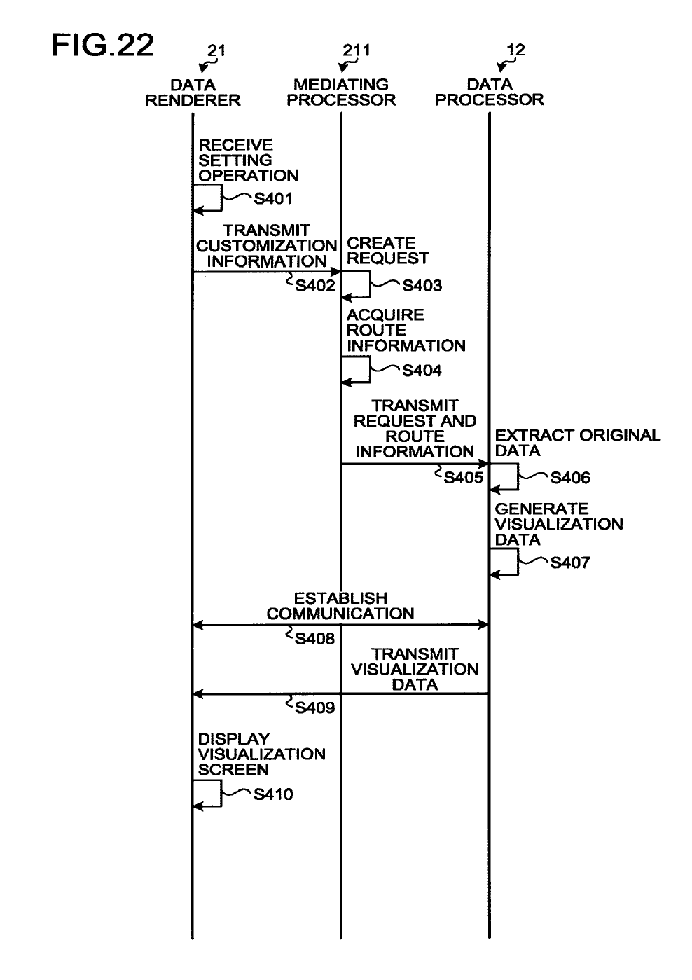

FIG. 22 is a sequence diagram exemplifying a flow of a process from a user performing a setting operation to the data renderer 21 displaying the visualization screen 41 in the data visualization system 201 according to the second embodiment. Upon reception of a setting operation by a user (S401), the data renderer 21 creates customization information indicating setting contents and transmits the customization information to the mediating processor 211 (S402). Upon reception of the customization information, the mediating processor 211 creates a request corresponding to the setting contents (in this example, a visualization data request) (S403), and route information based on an IP address and the like of the data renderer 21 (the terminal device 3) as a transmission source of the customization information (S404). Subsequently, the mediating processor 211 transmits the request and the route information to the data processor 12 (S405).

Upon reception of the request and the route information, the data processor 12 extracts original data corresponding to the request from the data source 11 (S406), and generates visualization data (S407). Subsequently, the data processor 12 establishes communication with the data renderer 21 (the terminal device 3) based on the route information (S408), and directly transmits the visualization data to the data renderer 21 (S409). The data renderer 21 displays the visualization screen 41 based on the received visualization data (S410).

In the above descriptions, there has been described an example in which visualization data is directly transmitted from the data processor 12 (the data management device 2) to the data renderer 21 (the terminal device 3); however, it is also possible to configure that not only visualization data, but also header data is directly transmitted from the data processor 12 (the data management device 2) to the data renderer 21 (the terminal device 3).

According to the present embodiment, aggregate data (visualization data and header data) generated by the data management device 2 (the data processor 12) can be transmitted to the terminal device 3 (the data renderer 21) without relayed via the server 4. Due to this configuration, it is possible to further decrease the risk of information leakage. Further, it is possible to maintain high security without providing any the encryption unit 104 of the data processor 12 and the decoding unit 122 of the data renderer 21 that encrypts and decodes visualization data and header data.

### Third Embodiment

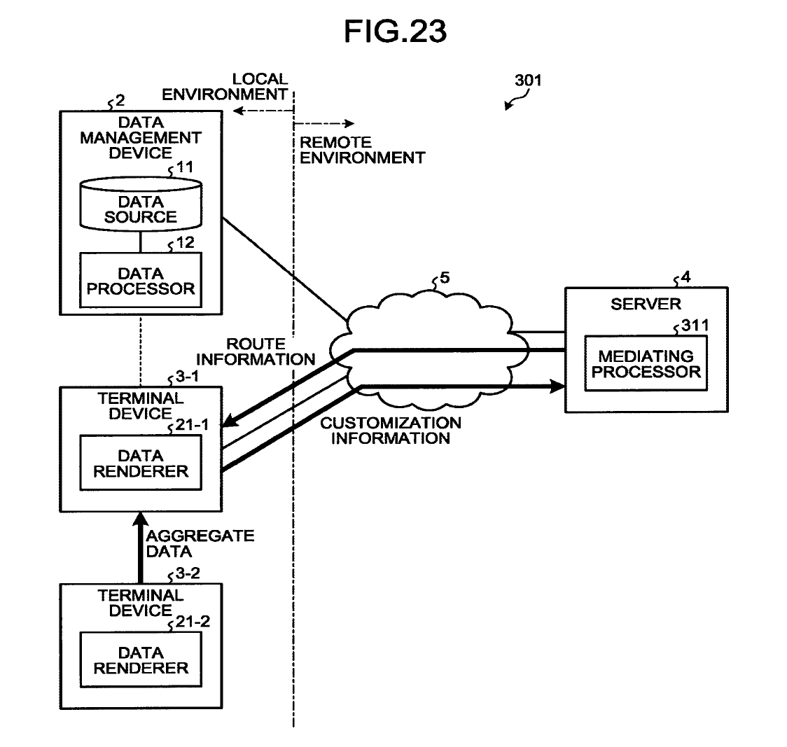

FIG. 23 is a diagram exemplifying a system configuration of a data visualization system 301 according to a third embodiment. The data visualization system 301 according to the present embodiment includes a unit for a first terminal device 3-1 to directly acquire aggregate data from a second terminal device 3-2.

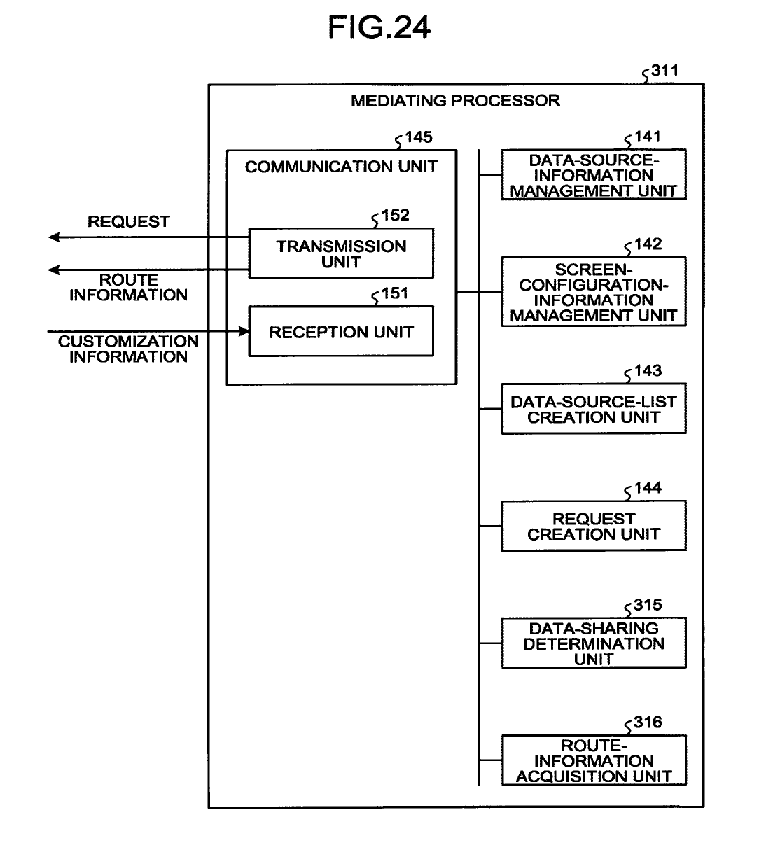

FIG. 24 is a block diagram exemplifying a functional configuration of a mediating processor 311 according to the third embodiment. The mediating processor 311 according to the present embodiment includes a data-sharing determination unit 315 and a route-information acquisition unit 316. Similarly to other functional units 141 to 145, the data-sharing determination unit 315 and the route-information acquisition unit 316 can be realized by one or plural integrated circuits.

The data-sharing determination unit 315 determines whether sharing (data sharing) of aggregate data can be performed between a terminal device 3 as a transmission source and another terminal device 3, based on a comparison between screen configuration information 45 corresponding to the terminal device 3 (in this example, the first terminal device 3-1) as the transmission source of customization information and screen configuration information 45 corresponding to another terminal device 3 (in this example, the second terminal device 3-2). The data-sharing determination unit 315 is configured by cooperation of the CPU 31, the RAM 32, the nonvolatile memory 34, and the like. The route-information acquisition unit 316 acquires route information for establishing communication among a plurality of terminal devices 3 that are determined to be capable of performing data sharing by the data-sharing determination unit 315. The route information may include, for example, an IP address, a port number, and the like of another terminal device 3 that is determined to be capable of performing data sharing. The route-information acquisition unit 316 is configured by cooperation of the CPU 31, the RAM 32, the communication I/F 36, and the like. The transmission unit 152 according to the present embodiment transmits a request to the data management device 2 (the data processor 12), and transmits route information to terminal devices 3 (any one or both of the first terminal device 3-1 and the second terminal device 3-2) that are capable of performing data sharing of route information.

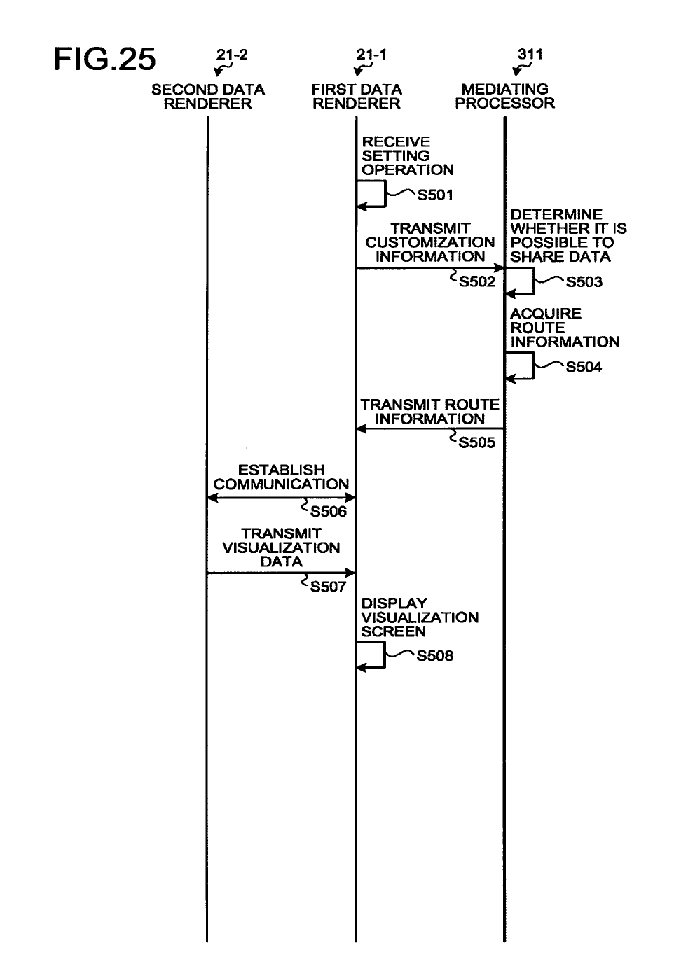

FIG. 25 is a sequence diagram exemplifying a flow of a process from a user performing a setting operation to a first data renderer 21-1 displaying the visualization screen 41 in the data visualization system 301 according to the third embodiment. Upon reception of a setting operation by a user (S501), the first data renderer 21-1 creates customization information indicating setting contents and transmits the customization information to the mediating processor 311 (S502). Upon reception of the customization information, the mediating processor 311 determines whether it is possible to share aggregate data (in this example, visualization data) between the first data renderer 21-1 and the second data renderer 21-2 (S503). When the data sharing is possible, the mediating processor 311 acquires route information for establishing direct communication between the first data renderer 21-1 and the second data renderer 21-2 (S504), and transmits the route information to the first data renderer 21-1 (S505). At this time, the route information can be transmitted to both of the first data renderer 21-1 and the second data renderer 21-2.

Upon reception of the route information, the first data renderer 21-1 establishes communication with the second data renderer 21-2 based on an IP address and the like included in the route information (S506). The second data renderer 21-2 directly transmits visualization data to the first data renderer 21-1 via a corresponding communication path (S507). The first data renderer 21-1 displays the visualization screen 41 based on the received visualization data (S508).

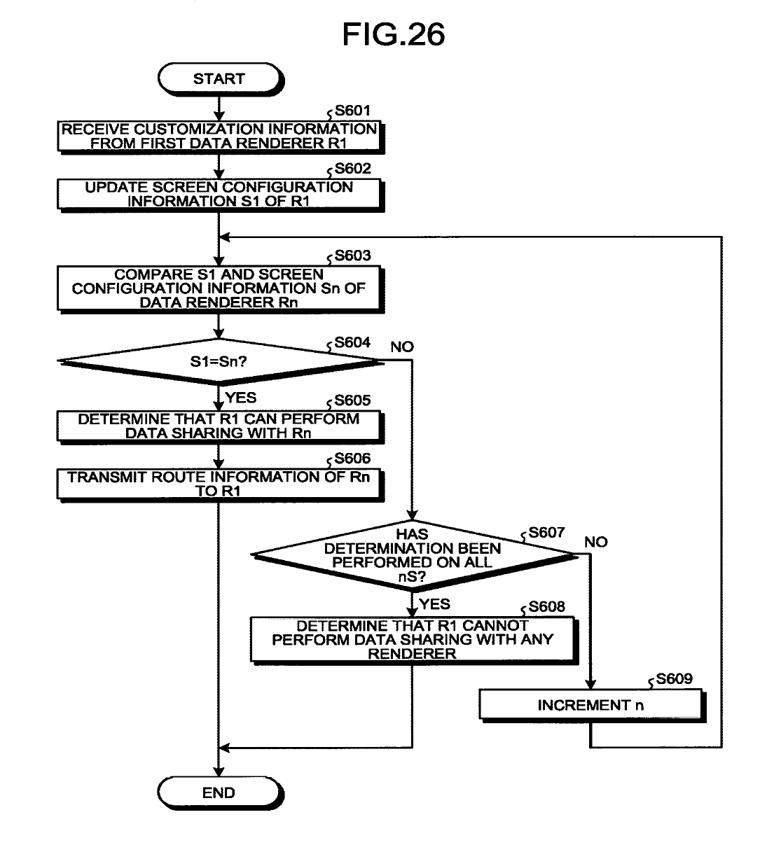

FIG. 26 is a flowchart exemplifying a flow of a process of determining data renderers 21 that are capable of sharing visualization data, among a plurality of data renderers 21-1 to 21-n in the third embodiment. Upon reception of customization information from the first data renderer 21-1 (R1) (S601), the data-sharing determination unit 315 updates first screen configuration information 45 (S1) corresponding to the first data renderer 21-1 (R1) based on the setting contents (S602). Subsequently, the data-sharing determination unit 315 compares the updated first screen configuration information 45 (S1) and nth screen configuration information 45 (Sn) corresponding to nth data renderer 21-n (Rn) (S603).

When predetermined items match with each other between the first screen configuration information 45 (S1) and the nth screen configuration information 45 (Sn) (YES at Step S604), the data-sharing determination unit 315 determines that data sharing can be performed between the first data renderer 21-1 (R1) and the nth data renderer 21-n (Rn) (S605), and transmits route information including an IP address, a port number, and the like of the nth data renderer 21-n (Rn) to the first data renderer 21-1 (R1) (S606). The predetermined items can be, for example, a chart ID, information within chart, and the like (see FIG. 9).

Meanwhile, when predetermined items do not match with each other between the first screen configuration information 45 (S1) and the nth screen configuration information (Sn) (NO at Step S604), it is determined whether all of the data renderers 21-2 to 21-n (the terminal devices 3-2 to 3-n) being connected to the mediating processor 311 (the server 4) have been determined (S607). When all of the data renderers 21-2 to 21-n have been determined (YES at Step S607), the data-sharing determination unit 315 determines that the first data renderer 21-1 (R1) cannot perform data sharing with any of the data renderers 21-2 to 21-n (S608). Meanwhile, when determination on all of the data renderers 21-2 to 21-n has not been made (NO at Step S607), the data-sharing determination unit 315 increments the value of n (S609), and performs Step S603 again.

In the above descriptions, an example in which visualization data is shared among a plurality of data renderers 21 (the terminal devices 3) has been described; however, it is also possible to configure that not only visualization data, but also header data is shared among these data renderers 21.

According to the present embodiment, when aggregate data (visualization data or header data) can be shared among a plurality of terminal devices 3 (the data renderers 21), transmission and reception of aggregate data are performed directly among these terminal devices 3. For example, when aggregate data required by the first data renderer 21-1 is already held in the second data renderer 21-2, the aggregate data is directly transmitted from the second data renderer 21-2 to the first data renderer 21-1. Accordingly, it is not necessary to cause the data processor 12 to newly generate aggregate data, and thus, for example, in a case where the same visualization screen 41 is viewed by a plurality of terminal devices 3, it is possible to reduce the processing load on the data processor 12. Further, because the number of times of processes of transmitting aggregate data and the like to the server 4 can be reduced, it is possible to decrease the risk of information leakage.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A visualization management device communicating with a terminal device that displays a visualization screen and a data management device that generates aggregate data in which original data is aggregated, the visualization management device comprising one or more circuitry configured to:
receive customization information indicating setting related to the visualization screen from the terminal device;
cause a storage to store therein screen configuration information indicating a screen configuration of the visualization screen based on the customization information;
create a request for generating the aggregate data based on the customization information and the screen configuration information; and
transmit the request to the data management device.

2. The visualization management device according to claim 1, wherein the circuitry further configured to:
receive the aggregate data from the data management device; and
transfer the received aggregate data to the terminal device.

3. The visualization management device according to claim 2, wherein the circuitry configured to relay the aggregate data that has been encrypted.

4. The visualization management device according to claim 1, wherein the circuitry further configured to:
create route information for establishing communication between the data management device and the terminal device; and
transmit the route information to the data management device or the terminal device.

5. The visualization management device according to claim 1, wherein the circuitry further configured to:
determine, based on a plurality of pieces of the screen configuration information of a plurality of the terminal devices, a plurality of the terminal devices that are capable of sharing the aggregate data;
create route information for establishing communication among the terminal devices that are capable of the sharing; and
transmit the route information to at least one of the terminal devices that are capable of the sharing data.

6. The visualization management device according to claim 1, wherein
the aggregate data includes visualization data handled as a rendering target and header data indicating characteristics of attribute values included in the original data for each attribute, and
the circuitry is configured to create a visualization data request for requesting the visualization data and a header data request for requesting the header data.

7. A data management device communicating with a visualization management device that creates a request for generating aggregate data to be visualized, the data management device comprising one or more circuitry configured to:
receive the request from the visualization management device;
generate the aggregate data from the original data according to the request; and
transmit the aggregate data to the visualization management device or a terminal device that displays a visualization screen.

8. A data visualization system comprising a data management device; a terminal device; and a visualization management device, wherein
the data management device includes one or more circuitry configured to:
receive a request for generating aggregate data to be visualized from the visualization management device; and
generate the aggregate data from the original data according to the request,
the terminal device includes one or more circuitry configured to:
create customization information indicating setting related to a visualization screen;
transmit the customization information to the visualization management device; and
perform a process of displaying the visualization screen based on the aggregate data,
the visualization management device includes one or more circuitry configured to:
receive the customization information from the terminal device;
cause a storage to store therein screen configuration information indicating a screen configuration of the visualization screen based on the customization information;
create the request based on the customization information and the screen configuration information; and
transmit the request to the data management device.

9. A visualization management method for visualizing data using a terminal device that displays a visualization screen, a data management device that generates aggregate data in which original data is aggregated, and a visualization management device that communicates with the terminal device and the data management device, the visualization management method comprising:
a process in which the visualization management device receives customization information indicating setting related to the visualization screen from the terminal device;
a process in which the visualization management device causes a storage to store therein screen configuration information indicating a screen configuration of the visualization screen based on the customization information;
a process in which the visualization management device creates a request for generating the aggregate data based on the customization information and the screen configuration information; and
a process in which the visualization management device transmits the request to the data management device.

10. A program product having a non-transitory computer readable medium including a program, wherein the program, when executed by a computer communicating with a terminal device that displays a visualization screen and a data management device that generates aggregate data in which original data is aggregated, causes the computer to execute:
receiving customization information indicating setting related to the visualization screen from the terminal device;
causing a storage to store screen configuration information indicating a screen configuration of the visualization screen based on the customization information;
creating a request for generating the aggregate data based on the customization information and the screen configuration information; and
transmitting the request to the data management device.
